(19) United States
(12) Patent Application Publication
(10) Pub. No.: US 2007/0294355 A1
(43) Pub. Date: Dec. 20, 2007

(54) Method and system for making a portable network user mailbox from an archived network post office without restoring to the original active post office

(75) Inventors: Gene Lauve, Kaufman, TX (US); Z. Hyattye O. A. Simmons, Allen, TX (US)

Correspondence Address: GARDERE WYNNE SEWELL LLP;INTELLECTUAL PROPERTY SECTION, 3000 THANKSGIVING TOWER, 1601 ELM ST, DALLAS, TX, 75201-4761, US

(73) Assignee: Dallas Area Rapid Transit

(21) Appl. No.: 11/471,374

(22) Filed: Jun. 19, 2006

(51) Int. Cl. G06F 15/16

(52) U.S. Cl. 709/206

(57) ABSTRACT

An exemplary method, system, and computer program product for retrieving selected e-mails from an archived location is provided that, in one embodiment, includes the following steps. Rebuilding an e-mail system post office on a network location from archived offline data to produce a rebuilt post office. Installing the e-mail system client software on a data processing system. Using the e-mail system client software to open a selected user's mailbox from the rebuilt post office. Creating a portable e-mail archive of the user's mailbox that does not require interaction with a network post office. Storing user selected e-mail to a storage device.

### TECHNICAL FIELD OF THE INVENTION

This invention relates in general to the field of computer software and, more particularly, to methods and systems for restoring selected archived electronic mail from optical or tape backup without replicating an existing e-mail system, restoring to a current live system, or recreating a legacy system.

### BACKGROUND OF THE INVENTION

Recovering selected e-mail corresponding to one or more particular users from a database containing encrypted e-mails for hundreds or thousands of users and corresponding to a specific time frame is a daunting task. To do this requires that very specific hardware and software must be implemented involving a great amount of time on the part of administrators. Such a task can easily run into the millions of dollars.

Furthermore, even recovering selected e-mails from an existing collaboration software solution that provides information workers with e-mail, calendaring, instant messaging, task management, and contact and document management functions or similar system is daunting. Current methods either require that the entire system be replicated separately from an existing active system at a cost of millions of dollars or replacing the data in the active system with archived data. The latter is simply unacceptable to an enterprise and would also result in a cost of millions of dollars due to lost productivity of employees for the downtime when their current e-mail is unavailable to them.

Typically an enterprise would simply not engage in such a task unless a very good reason existed to do so. One such motivation is the requirement to produce certain electronic e-mails as part of a discovery request during civil litigation. However, typically, the discovery requests only require that e-mails from or to specified individuals during a specific time frame be turned over. Such documents may only comprise a small percentage of the entire database of e-mails contained on the backup media. Furthermore, in the prior art, searching for and then extracting a specific users' email could normally only be performed on a live system involving the entire post office, which may be hundreds of gigabytes of data. Again, the latter would be unacceptable to an enterprise because it would mean lost productivity of employees for the downtime when their current e-mail was unavailable to them because it was being used for this retrieval process.

### SUMMARY OF THE INVENTION

The present invention addresses the problem of reducing the cost of producing electronic mail messages from a post office system in a novel manner. According to one aspect of the invention, a method, system, and computer program product for retrieving selected archived e-mails from an archived location without replicating an existing system, replacing the data on an existing running system, or reinstalling an entire legacy software system is provided that includes, in one embodiment, the following steps. Rebuilding a post office on a network location from archived offline data to produce a rebuilt post office. Installing the post office system client software on a data processing system. Using the post office system client software to open a selected user's mailbox from the rebuilt post office. Creating a portable e-mail archive of the user's mailbox that does not require interaction with a network post office. Storing user selected e-mail to a storage device.

### BRIEF DESCRIPTION OF THE DRAWINGS

For a more complete understanding of the present invention and the advantages thereof, reference is now made to the following brief description, taken in connection with the accompanying drawings and detailed description, wherein like reference numerals represent like parts, in which:

FIG. 1A is a pictorial representation of a distributed data processing system in which the present invention may be implemented;

FIG. 1B is a block diagram illustrating exemplary method of how an e-mail may be stored in an e-mail system;

FIG. 2 is a block diagram of a data processing system which may be implemented as a server in accordance with the present invention;

FIG. 3 is a block diagram of a data processing system in which the present invention may be implemented;

FIG. 4 is an exemplary generalized high level process flow and program function for retrieving selected e-mails from an archived collection of e-mails corresponding to an e-mail software system in accordance with one embodiment of the present invention; and

FIG. 5 is an exemplary process flow and program function for retrieving selected e-mails from an archived collection of e-mails corresponding to a Novell GroupWise® system in accordance with one embodiment of the present invention.

### DETAILED DESCRIPTION OF THE INVENTION

It should be understood at the outset that although an exemplary implementation of the present invention is illustrated below, the present invention may be implemented using any number of techniques, whether currently known or in existence. The present invention should in no way be limited to the exemplary implementations, drawings, and techniques illustrated below, including the exemplary design and implementation illustrated and described herein. Additionally, the drawings contained herein are not necessarily drawn to scale.

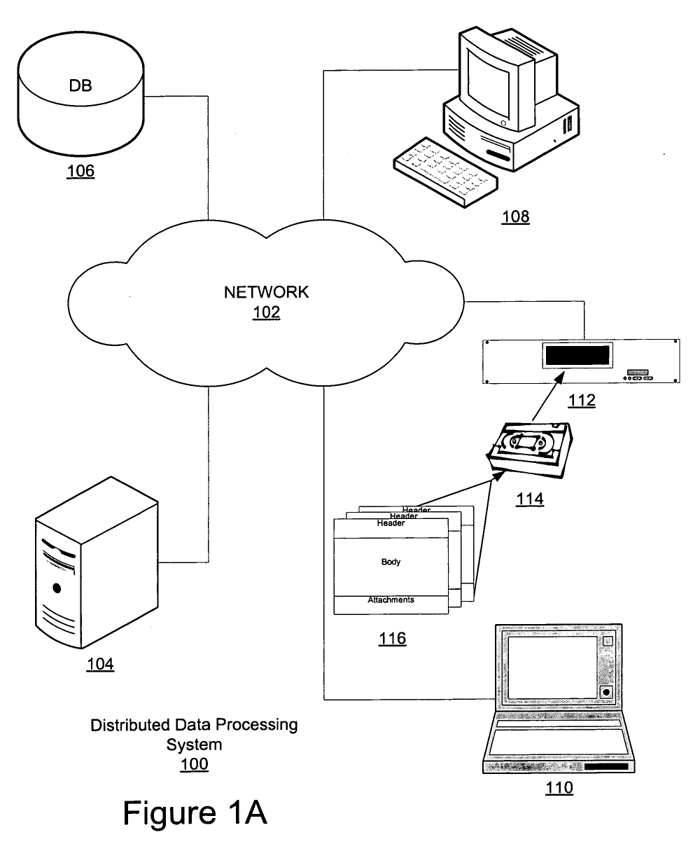

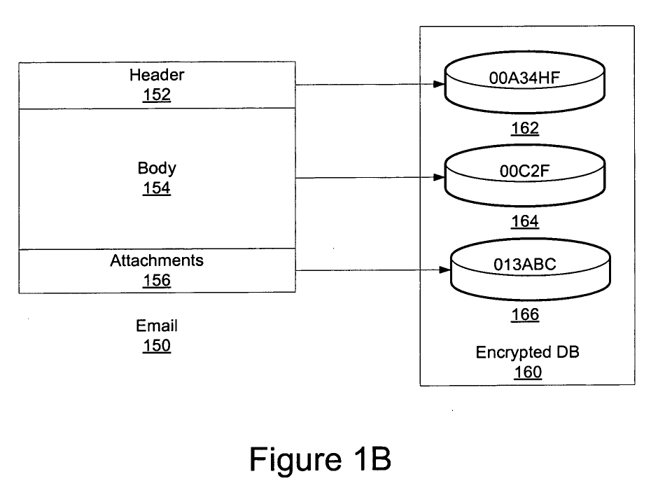

With reference now to the figures, and in particular with reference to FIG. 1A, a pictorial representation of a distributed data processing system is depicted in which the present invention may be implemented.

Distributed data processing system 100 is a network of computers. This is a type of system in which the present invention for recovering selected archived e-mails without replicating an existing e-mail system, restoring to a current live system, or recreating a legacy system may be implemented. Replicating an existing e-mail system or recreating a legacy e-mail system is cost and time prohibitive. The cost of doing so may run into several millions of dollars. Furthermore, restoring to a live system is unsatisfactory, since user's current e-mail will not be available to them because it will have been replaced with archived data. FIG. 1B is a block diagram illustrating an exemplary method of how an e-mail may be stored in an e-mail software system, such as, for example, a collaborative software system that includes e-mail as one of its functions. The e-mail 150 comprises a header 152, a body 154, and optional attachments 156 and are stored in an encrypted database 160 as separate encrypted files 162, 164, and 166 with file names that provide no indication as to the user. The database 160 may be backed up to a backup tape from time to time and the encrypted nature of the files 162, 164, and 166 is preserved on the backup tape. Furthermore, the e-mails from multiple users are stored together and the total size of this data for an enterprise may exceed seventy-five Gigabytes per electronic post office. Furthermore, an enterprise may have several post office each with its own backup. Therefore, locating and retrieving a selected user's e-mails is massively difficult, time consuming, and expensive since the entire system must be replicated, current data replaced with archived data, or the legacy system with associated hardware requirements must be reconfigured in order to retrieve the desired e-mails. Furthermore, reinstalling and running the replicated or legacy system or replacing existing data with archived data may result in recovering a massive amount of data files that are not e-mails which greatly complicates the task of locating and recovering selected e-mails. However, the method and system disclosed herein overcomes those difficulties enabling an enterprise to recover selected e-mails, perhaps, for example, in order to comply with a discovery request in a legal proceeding. Thus, the present invention can massively reduce the costs associated with complying with discovery requests in civil and criminal lawsuits. The e-mails sought to be recovered may correspond to a few individuals and span a discrete time span.

Distributed data processing system 100 contains network 102, which is the medium used to provide communications links between various devices and computers connected within distributed data processing system 100. Network 102 may include permanent connections, such as wire or fiber optic cables, or temporary connections made through telephone connections.

In the depicted example, server 104 is connected to network 102, along with storage unit 106. In addition, clients 108 and 110 as well as tape drive 112 are also connected to network 102. These clients, 108 and 110, may be, for example, personal computers or network computers. In the depicted example, client 108 is a desktop computer and client 110 is a laptop computer. For purposes of this application, a network computer is any computer coupled to a network that receives a program or other application from another computer coupled to the network. Tape drive 112 provides server 104 and clients 108 and 110 with access to offline storage tapes such as, for example backup storage tape 114, which are typically used to backup system data in case of catastrophic failure. In the depicted example, backup storage tape 114 readable by tape drive 112 includes archived electronic mail (e-mail) from a current or legacy system for which a portion of which is desired to be retrieved without having to go through the time and expense of replicating the entire current system, replacing existing data in an active system with archived data, or restoring the entire legacy system.

In the depicted example, server 104 provides a restored Electronic Post Office with restored archived e-mails to clients 108 and 110 from which selected e-mails for selected users may be retrieved by clients 108 and 110. Clients 108 and 110 are clients to server 104. Distributed data processing system 100 may include additional servers, clients, and other devices not shown.

In the depicted example, distributed data processing system 100 is an intranet, with network 102 representing an enterprise collection of networks and gateways that use, for example, the TCP/IP suite of protocols to communicate with one another. At the heart of the intranet is a backbone of high-speed data communication lines between major nodes or host computers consisting of tens to thousands of computer systems that route data and messages. Of course, distributed data processing system 100 also may be implemented as a number of different types of networks such as, for example, the Internet utilizing, for example, a Virtual Private Network (VPN), a Local Area Network (LAN), or a Wide Area Network (WAN).

An electronic post office, such as, for example, a GroupWise® Post Office, is restored or copied from tape 114 to server 104. GroupWise® is a product and registered trademark of Novell, Inc. of Waltham, Mass. Novell GroupWise® is a complete collaboration software solution that provides information workers with e-mail, calendaring, instant messaging, task management, and contact and document management functions. Other similar software solutions include Microsoft Exchange, a product of the Microsoft Corporation of Redmond, Wash. The processes and systems described herein have particular applicability to GroupWise® software systems, but are not limited to such.

The Domain Directory for the electronic post office is also copied from tape 114 to server 104. The Domain Directory must be restored or copied to a separate location from the Post Office. It is usually necessary to copy the domain directory because many software suites, such as, for example, GroupWise®, require that a client connect to the domain directory in order to rebuild the post office.

Once the post office has been restored or copied, a system administrator locates and breaks the passwords for the selected user's mailbox. The administrator may use any of a number of methods for breaking passwords which are well known to those of ordinary skill in the art. Once the selected passwords for the selected user's mailbox are broken, the passwords are reset to a character string selected by the administrator. The post office is then rebuilt using the domain directory. Since the rebuilt post office is not a live system and no agent is running, the administrator needs to incorporate changes to the passwords as well as any other changes to the rebuilt post office.

A user or administrator should also install the post office client on the desktop 108 or laptop computer 110. For implementations in which e-mail from a GroupWise® system is desired to be recovered, this requires installing a Novell GroupWise® Client on a desktop computer 108 or laptop computer 110. The Post Office Agent is also installed on the same one of desktop computer 108 or laptop computer 110. For GroupWise®, this is an NT version of the GroupWise® Post Office Agent. This is a mini program that can run on a desktop or laptop computer that mimics the action of a real post office. The post office client, such as Novell GroupWise® Client, will interpret, respond, and interact with this agent as if it is a real live active post office. For implementations utilizing GroupWise®, the GroupWise® Post Office Agent is an applet that may be downloaded from Novell's web site. The user or administrator should then modify the home directory in order to notify the post office client as to the location of the archived e-mail directory which, in the current embodiment, is located on server 104. For GroupWise®, modifying the home directory involves editing a configuration file and then running the executable file after the configuration has been modified.

Prior to running, the GroupWise® Desktop Client must be configured. This puts an icon on the desktop. The properties for the GroupWise® Desktop Client must be altered by, for example, right clicking the icon with a mouse or other selection device and selecting properties from the menu that is presented. The properties must be modified to supply the location of the GroupWise® executable file and to supply the location of the GroupWise® user. This is to ensure that the e-mail that is retrieved belongs to the particular user desired and not to the user that is signed onto the desktop 108 or laptop 110 client. Once this is accomplished, the administrator gets the post office box running before opening GroupWise®. The user or administrator then runs GroupWise® with configuration for the user whose e-mail is desired to be retrieved. Thus, GroupWise® opens up the user's account without any need for passwords.

Once the user's account has been opened and all files and trash have been recovered, the user should open up the trash folder and undelete all deleted files. This is because a feature of Novel GroupWise® called “Hit the Road” that allows for a portable mailbox to be created will not move items in the trash folder to a portable e-mail account. The user should also go into and turn off the auto delete feature of GroupWise® to ensure that GroupWise® does not try to do any automatic cleanup.

The located e-mail, if any, are stored on the on the desktop 108 or laptop 110 and the process is repeated for each backup tape. A Graphical User Interface (GUI) may be configured on the desktop 108 or laptop 110 allowing a user to pull up e-mails for one or more selected users copied from two or more backup tapes. The GUI may be used to organize and choose from various versions of the selected user's e-mail. The GUI program, located e-mail, and post office program desktop client, such as, for example, GroupWise® Desktop Client, may be compressed into a compressed file, such as, for example, a “Zip” file and produced on portable computer readable media such as, for example, a DVD. Thus, the contents requested in discovery by an opposing party may be produced in a format that is easily transmitted to the opposing party and that contains everything necessary to access and read the selected e-mails.

FIG. 1 is intended as an example and not as an architectural limitation for the processes of the present invention.

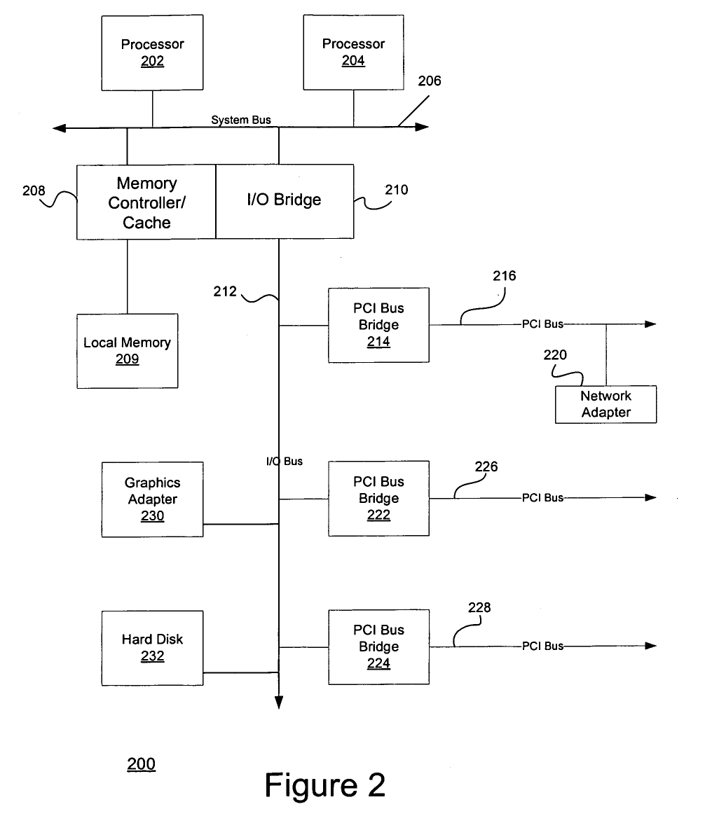

Referring to FIG. 2, a block diagram of a data processing system which may be implemented as a server, such as server 104 in FIG. 1, is depicted in accordance with the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of network adapters 220 may be connected to PCI bus 216 implemented as, for example, 10/100 Mbps Ethernet LAN Adapters or a Gigabyte Ethernet Network Adapter. Typical PCI bus implementations will support four PCI expansion slots or add-in connectors. Communications links to network computers 108-112 in FIG. 1 may be provided through network adapter 220 connected to PCI local bus 216 through add-in boards.

Additional PCI bus bridges 222 and 224 provide interfaces for additional PCI buses 226 and 228, from which additional modems or network adapters may be supported. In this manner, server 200 allows connections to multiple network computers. A memory mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The GroupWise® Post Office may be copied or restored to data processing system 200 via, for example, network adapter 220. The domain directory for GroupWise® or other similar software product may also be copied to data processing system 200 via network adapter 220. An administrator may then locate and break passwords for one or more selected user's mailboxes and rebuild the GroupWise® Post Office to then be used and accessed by a desktop or laptop computer.

Data processing system 200 may be implemented as, for example, an AlphaServer GS1280 running a UNIX® operating system. AlphaServer GS1280 is a product of the Hewlett-Packard Company of Palo Alto, Calif. “AlphaServer” is a trademark of Hewlett-Packard Company. “UNIX®” is a registered trademark of The Open Group in the United States and other countries. Data processing system 200 may also be implemented as, for example, a ProLiant DL360 G2 Server running any one of a Linux®, or Novell Operating System 6.5 Service with Pack 3. ProLiant DL360 G2 Server is also a product of the Hewlett-Packard Company of Palo Alto, Calif. Linux® is a registered trademark of Linus Torvalds in the U.S. and other countries. Novell Operating System 6.5 is a product of Novell, Inc. of Waltham, Mass.

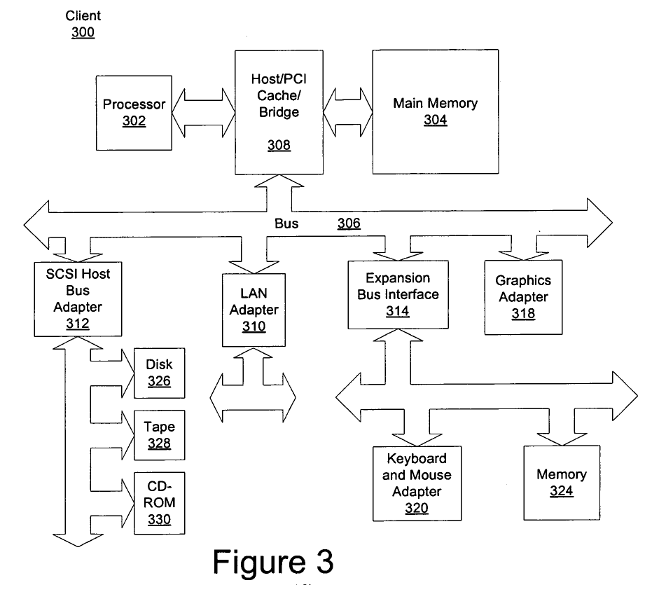

With reference now to FIG. 3, a block diagram of a data processing system in which the present invention may be implemented is illustrated. Data processing system 300 is an example of a client computer. Data processing system 300 employs a peripheral component interconnect (PCI) local bus architecture. Although the depicted example employs a PCI bus, other bus architectures, such as Micro Channel and ISA, may be used. Processor 302 and main memory 304 are connected to PCI local bus 306 through PCI bridge 308. PCI bridge 308 may also include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, graphics adapter 318 is connected to PCI local bus 306 by add-in boards inserted into expansion slots. Expansion bus interface 314 provides a connection for a keyboard and mouse adapter 320 and additional memory 324. In the depicted example, SCSI host bus adapter 312 provides a connection for hard disk drive 326, tape drive 328, CD-ROM drive 330, and digital video disc read only memory drive (DVD-ROM) 332. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP or Windows 2000 with service pack 4, which are available from Microsoft Corporation of Redmond, Wash. “Windows XP” and “Windows 2000” are trademarks of Microsoft Corporation. An object oriented programming system, such as Java, may run in conjunction with the operating system, providing calls to the operating system from Java programs or applications executing on data processing system 300. Instructions for the operating system, the object-oriented operating system, and applications or programs are located on a storage device, such as hard disk drive 326, and may be loaded into main memory 304 for execution by processor 302.

A Novell GroupWise®Client and an NT version of a GroupWise® Post Office Agent may be installed on data processing system 300. A user may then use the GroupWise® Client to open a selected user's mailbox from the rebuilt GroupWise® Post Office located on a server, such as, for example, data processing system 200. The “Hit the Road” feature of the GroupWise® Client may then be used to create a “portable” e-mail archive which then allows the user to locate and open selected e-mail without connecting to a live active Post Office. A Graphical User Interface (GUI) may also be loaded onto data processing system 300 allowing a user a simplified means of locating, organizing and viewing selected e-mails. For GroupWise® implementations, the GUI may be GroupWise Launch Wrapper. Once the desired e-mails have been located, the selected e-mails and associated software necessary to retrieve and view the e-mails may be saved to a portable computer readable media, such as, for example, a DVD. Prior to saving to the portable computer readable media, the desired e-mails and associated software may also be compressed into, for example, a “Zip” file.

Those of ordinary skill in the art will appreciate that the hardware in FIG. 3 may vary depending on the implementation. For example, other peripheral devices, such as optical disk drives and the like, may be used in addition to or in place of the hardware depicted in FIG. 3. The depicted example is not meant to imply architectural limitations with respect to the present invention. For example, the processes of the present invention may be applied to multiprocessor data processing systems.

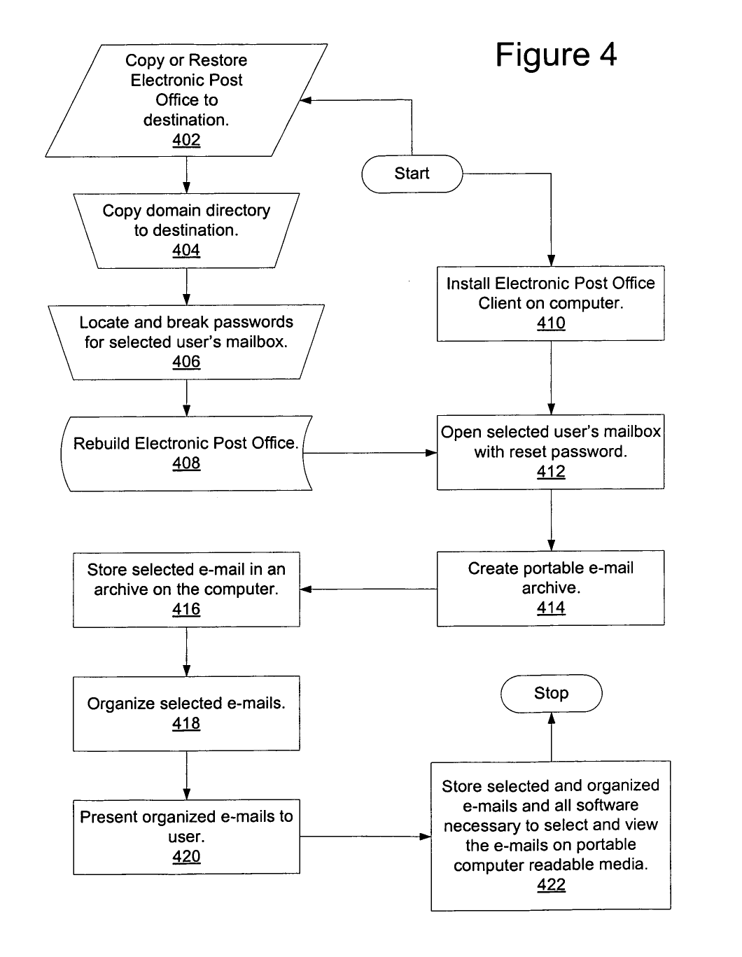

With reference now to FIG. 4, an exemplary generalized high level process flow and program function for retrieving selected e-mails from an archived collection of e-mails corresponding to a current or legacy software e-mail system is depicted in accordance with one embodiment of the present invention.

A user or administrator copies or restores an electronic post office to a network destination, such as, for example, to server 104 depicted in FIG. 1 from an archived location, such as, for example, a backup tape (step 402). The domain directory for the electronic post office is also copied to the network destination (step 404). The user or administrator then locates and breaks the passwords for the selected user's mailbox (step 406). Such methods are well known to those skilled in the art. It is necessary to break the password for the mailbox since the e-mail files are encrypted and access to them is denied unless the appropriate password is supplied. Once the passwords are broken and a new password is set for the appropriate user's mailbox, the administrator rebuilds the electronic post office (step 408).

An electronic post office client is installed on a computer, such as, for example, desktop computer 108 or laptop computer 110 depicted in FIG. 1 (step 410). The selected user's mailbox is then opened from the rebuilt electronic post office using the reset password (step 412). A portable e-mail archive is then created wherein the portable e-mail archive does not require access to an active live post office to function (step 414). The selected e-mails are then stored on the computer (step 416) and may be organized (step 418) and presented to a user (step 420). The selected and organized e-mails and all software necessary to select and view the e-mails may be saved to portable computer readable media (step 422).

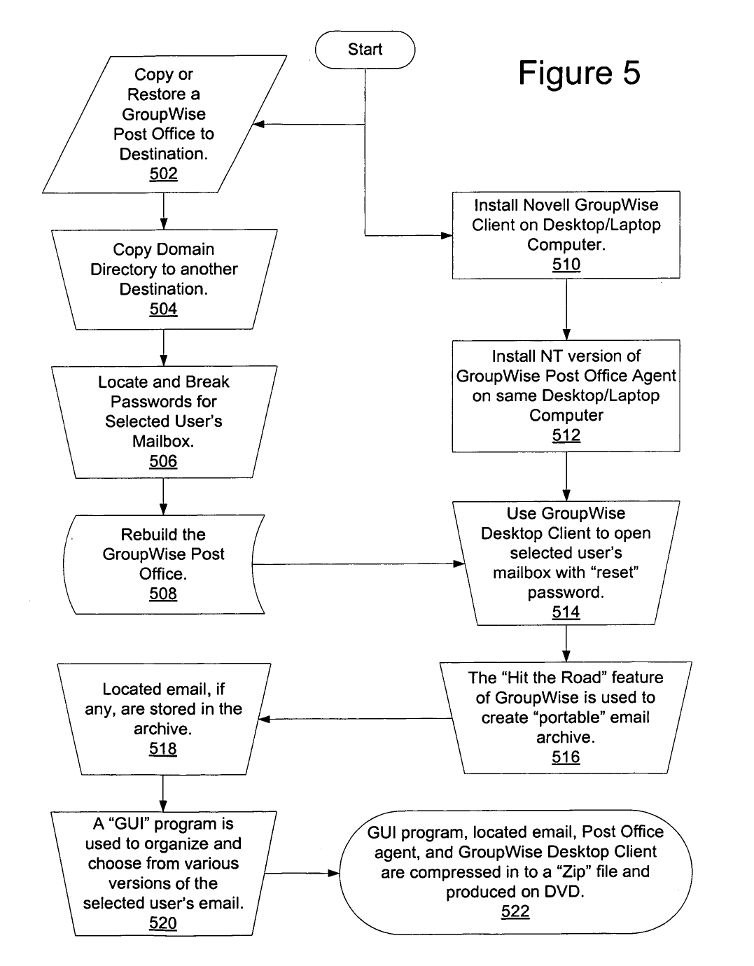

With reference now to FIG. 5, an exemplary process flow and program function for retrieving selected e-mails from an archived collection of e-mails corresponding to a Novell GroupWise® system is depicted in accordance with one embodiment of the present invention.

A system administrator or user copies or restores a GroupWise® Post Office from an archived source to a network destination, such as, for example, server 104 depicted in FIG. 1 (step 502). The GroupWise® Post Office contains, among other items, the entire database of encrypted e-mails from all users for as they existed at a specified time. The domain directory is also copied from an archived source to the network destination (step 504). Generally, the domain directory is located on the backup tape but is copied to a different location than the post office during the restore process. Therefore, it generally must by copied directly. Copying the domain directory allows a user to access and do work on the Post Office since Novel GroupWise® generally requires that a client connect to the domain in order to do work on the Post Office. The administrator locates, breaks, and resets the passwords for a selected user's mailbox (step 506). This enables administrator to retrieve and view e-mail from the selected user's mailbox. The selected user may have been selected, for example, because e-mails to and from that user for a specified time frame were requested by an opposing party during discovery in a legal proceeding. The administrator then rebuilds the GroupWise® Post Office to ensure that the Post Office utilizes the reset passwords and not the original passwords.

An administrator installs Novell GroupWise® Client on a computer such as, for example, desktop computer 108 or laptop computer 110 depicted in FIG. 1 (step 510). The administrator then installs an NT version of GroupWise® Post Office Agent on the same computer (step 512). This agent mimics the action of a real post office. The GroupWise® client will respond to this agent as if an active post office was running. This GroupWise® Post Office Agent is an applet that is downloadable from Novell. The home directory for the GroupWise® client must be changed to the location of the rebuilt post office. The “Hit the Road” feature of GroupWise® is used to create a “portable” e-mail archive on the computer (step 516). The “portable” e-mail archive does not require access to the network directory in order to function. “Hit the Road” is a feature provided by Novell GroupWise® to create a “portable” e-mail from a live post office, but was never intended to run from an archived post office, which is the purpose of the GroupWise® Post Office Agent in mimicking a live post office in order for the “Hit the Road” feature to work properly with an archived post office.

Once the “portable” e-mail archive has been created on the computer, the administrator or other user can browse the e-mails for the selected user and locate and save the desired e-mails, for example, e-mails matching a valid discovery request from an opposing party in litigation proceedings (step 518). Thus, a database that may have contained tens of Gigabytes or more of information may be paired down to a much more manageable size containing only those e-mails that are desired to be retrieved and a size that is more likely to be able to be saved to a portable persistent memory computer readable media, such as, for example, a compact disc (CD) or DVD.

A Graphical User Interface (GUI), such as, for example, GroupWise Launch Wrapper, a product of Novel, may be used to organize and choose from various versions of the selected user's e-mail (step 520). The GUI, selected e-mail, Post Office agent, and GroupWise Desktop Client are compressed into, for example, a “Zip” file and produced on a portable computer readable media, such as, for example, a DVD (step 522). This provides, among other things, a convenient means of producing electronic documents in response to a discovery request in a civil litigation matter.

To aid the Patent Office, and any readers of any patent issued on this application in interpreting the claims appended hereto, it is noted that applicant does not intend any of the appended claims to invoke paragraph 6 of 35 U.S.C. §112 as it exists on the date of filing unless the words “means for” are used in the particular claim. Furthermore, none of the description in the present application should be read as implying that any particular element, step, or function is an essential element which must be included in the claim scope: THE SCOPE OF THE PATENTED SUBJECT MATTER IS DEFINED ONLY BY THE ALLOWED CLAIMS. Thus, the extent of legal protection will be determined by the limitations recited in the allowed claims and their equivalents. Unless explicitly recited, other aspects of the present invention as described in this specification do not limit the scope of the claims.

As used herein, the terms “comprises”, “comprising”, or any other variation thereof, are intended to cover a non-exclusive inclusion, such that a process, method, article, or apparatus that comprises a list of elements does not necessarily include only those elements but may include other elements not expressly listed or inherent to such process, method, article, or apparatus. Furthermore, no element described herein is required for the practice of the invention unless expressly described as “essential” or “critical”.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such a floppy disc, a hard disk drive, a RAM, and CD-ROMs and transmission-type media such as digital and analog communications links.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for obtaining archived electronic mail, the method comprising:
rebuilding an electronic post office on a network location from archived offline data to produce a rebuilt post office;
installing the e-mail system client software on a data processing system;
using the e-mail system client software to open a selected user's mailbox from the rebuilt post office;
creating a portable e-mail archive of the user's mailbox that does not require interaction with a network post office; and
storing user selected e-mail to a storage device, wherein the e-mail system does not need to be replicated or have its data replaced and wherein a legacy e-mail system is not recreated.

2. The method as recited in claim 1, wherein rebuilding the e-mail system post office comprises restoring the e-mail system post office to the network location from an archived location.

3. The method as recited in claim 1, wherein rebuilding the e-mail system post office comprises copying a domain directory to the network location from an archived location.

4. The method as recited in claim 1, wherein rebuilding the e-mail system post office comprises locating, breaking, and resetting the password for a selected user's mailbox.

5. The method as recited in claim 1, further comprising installing an e-mail system post office agent on the data processing system.

6. The method as recited in claim 1, wherein the e-mail system is Novell GroupWise®.

7. The method as recited in claim 1, further comprising providing a graphical user interface for organizing and presenting the e-mails to a user.

8. The method as recited in claim 1, wherein storing the selected e-mails comprises compressing the e-mail data files so as to require less space for storage.

9. The method as recited in claim 1, wherein the archived offline data comprises one of computer readable tape media, compact disk, and DVD.

10. The method as recited in claim 1, wherein the e-mail system is a collaborative software solution.

11. A computer program product in a computer readable media for use in a data processing system for obtaining archived electronic mail, the method comprising:
first instructions for rebuilding an electronic post office on a network location from archived offline data to produce a rebuilt post office;
second instructions for installing the e-mail system client software on a data processing system;
third instructions for using the e-mail system client software to open a selected user's mailbox from the rebuilt post office;
fourth instructions for creating a portable e-mail archive of the user's mailbox that does not require interaction with a network post office; and
fifth instructions for storing user selected e-mail to a storage device, wherein the e-mail system does not need to be replicated or have its data replaced and wherein a legacy e-mail system is not recreated.

12. The computer program product as recited in claim 11, wherein rebuilding the e-mail system post office comprises restoring the e-mail system post office to the network location from an archived location.

13. The computer program product as recited in claim 11, wherein rebuilding the e-mail system post office comprises copying a domain directory to the network location from an archived location.

14. The computer program product as recited in claim 11, wherein rebuilding the e-mail system post office comprises locating, breaking, and resetting the password for a selected user's mailbox.

15. The computer program product as recited in claim 11, further comprising sixth instructions for installing an e-mail system post office agent on the data processing system.

16. The computer program product as recited in claim 11, wherein the e-mail system is Novell GroupWise®.

17. The computer program product as recited in claim 11, further comprising sixth instructions for providing a graphical user interface for organizing and presenting the e-mails to a user.

18. The computer program product as recited in claim 11, wherein storing the selected e-mails comprises compressing the e-mail data files so as to require less space for storage.

19. The computer program product as recited in claim 11, wherein the archived offline data comprises one of computer readable tape media, compact disk, and DVD.

20. The computer program product as recited in claim 11, wherein the e-mail system is a collaborative software solution.

21. A system for obtaining archived electronic mail, the method comprising:
first means for rebuilding an electronic post office on a network location from archived offline data to produce a rebuilt post office;
second means for installing the e-mail system client software on a data processing system;
third means for using the e-mail system client software to open a selected user's mailbox from the rebuilt post office;
fourth means for creating a portable e-mail archive of the user's mailbox that does not require interaction with a network post office; and
fifth means for storing user selected e-mail to a storage device, wherein the e-mail system does not need to be replicated or have its data replaced and wherein a legacy e-mail system is not recreated.

22. The system as recited in claim 21, wherein rebuilding the e-mail system post office comprises restoring the e-mail system post office to the network location from an archived location.

23. The system as recited in claim 21, wherein rebuilding the e-mail system post office comprises copying a domain directory to the network location from an archived location.

24. The system as recited in claim 21, wherein rebuilding the e-mail system post office comprises locating, breaking, and resetting the password for a selected user's mailbox.

25. The system as recited in claim 21, further comprising sixth means for installing an e-mail system post office agent on the data processing system.

26. The system as recited in claim 21, wherein the e-mail system is Novell GroupWise®.

27. The system as recited in claim 21, further comprising sixth means for providing a graphical user interface for organizing and presenting the e-mails to a user.

28. The system as recited in claim 21, wherein storing the selected e-mails comprises compressing the e-mail data files so as to require less space for storage.

29. The system as recited in claim 21, wherein the archived offline data comprises one of computer readable tape media, compact disk, and DVD.

30. The system as recited in claim 21, wherein the e-mail system is a collaborative software solution.
